(19) United States
(12) Patent Application Publication
(10) Pub. No.: US 2020/0268584 A1
(43) Pub. Date: Aug. 27, 2020

(54) SYSTEMS, DEVICES, AND METHODS FOR THERAPEUTIC LOADING OF A JOINT

(71) Applicant: AESCLEPIUS CORPORATION, La Jolla, CA (US)

(72) Inventor: Adam H. Hsieh, La Jolla, CA (US)

(21) Appl. No.: 16/804,423

(22) Filed: Feb. 28, 2020

Related U.S. Application Data
(63) Continuation of application No. PCT/US18/49521, filed on Sep. 5, 2018.
(60) Provisional application No. 62/554,511, filed on Sep. 5, 2017.

(51) Int. Cl. A61H 1/02

(52) U.S. Cl. CPC A61H 1/024; A61H 2201/0192; A61H 2201/1207; A61H 2201/165; A61H 2201/0157; A61H 2201/1664; A61H 2230/625; A61H 2201/5097; A61H 2201/1642; A61H 2230/505; A61H 2230/065; A61H 2230/045; A61H 2201/5007

(57) ABSTRACT

Systems, devices, and methods are provided for therapeutic loading of a joint, such as a knee joint. Generally, a wearable device is provided, comprising a first subassembly comprising a first motor configured to apply a predetermined force to a joint through an adjustable connecting element; a second subassembly comprising an adjustable cuff coupled to the adjustable connecting element and an appendage adjacent to the joint; and a second motor configured to cause the joint to articulate according to a predetermined range of motion at a predetermined velocity. The wearable device may further comprise a controller unit configured to control the predetermined force, predetermined range of motion, and predetermined velocity.

### CROSS-REFERENCE TO RELATED APPLICATIONS

This application is a continuation of International Patent Application No. PCT/US18//49521, filed Sep. 5, 2018, which claims priority to and the benefit of U.S. Provisional Patent Application No. 62/554,511 filed Sep. 5, 2017, both of which are incorporated by reference herein in their entireties for all purposes.

### FIELD

The subject matter described herein relates generally to systems, devices, and methods for therapeutic loading of a joint. In particular, described herein are embodiments of wearable devices, and methods and systems relating thereto, for applying a predetermined force to a joint, such as a knee joint, and for articulating the joint according to a predetermined range of motion at a predetermined velocity.

### BACKGROUND

Osteoarthritis is a degenerative joint condition in which the articular cartilage in a joint begins to break down. It is conservatively estimated that osteoarthritis affects approximately twenty-seven million Americans in the United States. The global prevalence of osteoarthritis, particularly in the knee joint, has steadily climbed over the past thirty years, and is projected to continue rising through the next several decades. Osteoarthritis occurs most frequently in the knees, hips, lower back and neck, small joints of the fingers, and the bases of the thumb and big toe, and can cause severe joint pain, swelling and stiffness. Left untreated, osteoarthritis can result in significantly reduced function and disability, and for severe cases may require joint replacement surgery.

Among the greatest risk factors for osteoarthritis are obesity and joint injury. In addition, elite athletes are also susceptible to osteoarthritis, likely due to repetitive high levels of cartilage stress and a greater propensity for joint injury. Inclusion of moderate levels of physical activity in one's daily routine has long been the prevailing mantra for cartilage health. There is evidence reported in the relevant literature indicating that active individuals are at lower risk for developing osteoarthritis compared with those who lead sedentary lifestyles. Even for existing osteoarthritis sufferers, exercise can have a beneficial effect on pain and function.

Despite the known benefits of exercise, however, many at-risk individuals do not have the time, means, health, or motivation to incorporate physical activity into their lives. Furthermore, the efficacy of supplements, such as glucosamine or chondroitin sulfate, in preventing or treating osteoarthritis is not scientifically proven. Recent scientific research has shown that low magnitude cyclic compression can help cells avoid deleterious effects of traumatic events in cartilage explants (i.e., independent of systemic and joint-related factors). However, development of a portable instrument that can apply such loads to cartilage in a safe and consistent manner, and which can substantially benefit joint function and help delay and prevent the onset of osteoarthritis, has been lacking.

Thus, needs exist for systems, devices and methods for therapeutic loading of a joint, such as a knee, and in particular, for the purpose of preventing and treating osteoarthritis.

### SUMMARY

Provided herein are example embodiments of systems, devices and methods for therapeutic loading of a joint. Generally, a portable device configured to be worn on a user's appendage is provided. The wearable device can include a first subassembly comprising a first motor coupled to an adjustable connecting element, wherein the first motor is configured to apply a predetermined force to a joint through the adjustable connecting element; a second subassembly comprising an adjustable cuff coupled to the adjustable connecting element and an appendage adjacent to the joint; and a second motor configured to cause the joint to articulate according to a predetermined range of motion, such as a flexion-extension motion, at a predetermined velocity.

In some embodiments, for example, the wearable device can be adapted for use with a knee joint, wherein the first subassembly of the device can further include a foot plate including one or more wheels that are configured to roll upon a ground surface as the knee joint is articulated.

In other embodiments, the wearable device can include a controller unit having one or more processors and a memory coupled thereto, the memory configured to store instructions that, when executed by the one or more processors, cause the one or more processors to perform one or more of the method steps described herein. In some embodiments, for example, the instructions, when executed by the one or more processors, can cause the one or more processors to maintain, increase, decrease, adjust or otherwise control at least one of the predetermined force of the first motor, the predetermined range of motion of the second motor, and the predetermined velocity of the second motor. In other embodiments, the instructions stored in memory, when executed by the one or more processors, can cause the one or more processors to set the predetermined force of the first motor, the predetermined range of motion of the second motor and/or the predetermined velocity of the second motor according to a programmable schedule.

In many of the embodiments disclosed herein, the controller unit of the wearable device can include a wireless communications module configured to transmit and receive data to and from a remote computing device according to one or more standard wireless networking protocols. In some embodiments, the wireless communications module can also be configured to wirelessly transmit commands to either or both of the first motor and/or the second motor.

In some embodiments, the controller unit of the wearable device can further include an analog-to-digital converter coupled to one or more sensors adapted to sense one or more physiological characteristics of the user of the wearable device. According to one aspect of some embodiments, the instructions stored in memory of the controller unit, when executed by the one or more processors, can cause the one or more processors to modify at least one of the predetermined force of the first motor, the predetermined range of motion of the second motor, or the predetermined velocity of the second motor, based at least in part on the one or more physiological characteristics sensed by the sensors.

The various configurations of these systems, methods and devices are described by way of the embodiments which are only examples. Other systems, devices, methods, features, improvements and advantages of the subject matter described herein are or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is a side view of an example embodiment of a wearable device for therapeutically loading a joint.

FIG. 2 is a perspective view of another example embodiment of a wearable device for therapeutically loading a joint.

FIG. 3 is a front view of an example embodiment of a wearable device for therapeutically loading a joint.

FIG. 4 is a bottom-up perspective view of an example embodiment of a wearable device for therapeutically loading a joint.

FIG. 5 is a side view of another example embodiment of a wearable device for therapeutically loading a joint.

FIG. 6 is a side view of another example embodiment of a wearable device for therapeutically loading a joint.

FIG. 7 is a block diagram of an example embodiment of a controller unit.

### DETAILED DESCRIPTION

Before the present subject matter is described in detail, it is to be understood that this disclosure is not limited to the particular embodiments described herein, as such may, of course, vary. It is also to be understood that the terminology used herein is for the purpose of describing particular embodiments only, and is not intended to be limiting, since the scope of the present disclosure will be limited only by the appended claims.

As used herein and in the appended claims, the singular forms “a,” “an,” and “the” include plural referents unless the context clearly dictates otherwise.

Generally, embodiments of the present disclosure include systems, devices, and methods for therapeutically loading of a joint. Accordingly, many embodiments include a wearable device, which can comprise a first subassembly comprising a first motor coupled to an adjustable connecting element, wherein the first motor is configured to apply a predetermined force to a joint through the adjustable connecting element; a second subassembly comprising an adjustable cuff coupled to the adjustable connecting element, wherein the adjustable cuff is further coupled to an appendage adjacent to the joint; and a second motor configured to cause the joint to articulate according to a predetermined range of motion at a predetermined velocity.

In some embodiments, the wearable device can also include a controller unit, comprising one or more processors, a memory coupled thereto, a mass storage device, a wireless communications module, an input module, an output module, one or more sensors for sensing one or more physiological characteristics of a user, and an analog-to-digital converter. According to one aspect of the disclosed embodiments, the memory can store instructions that when executed by the one or more processors, cause the one or more processors to perform any or all of the method steps described herein. In some embodiments, for example, instructions stored in memory of the controller unit, when executed by the one or more processors, can cause the one or more processors to maintain, increase, decrease, adjust or otherwise control at least one of the predetermined force of the first motor, the predetermined range of motion of the second motor, and the predetermined velocity of the second motor.

According to another aspect of the embodiments disclosed herein, the controller unit of the wearable device can include a wireless communications module adapted to transmit and/or receive data from one or more remote devices over a network according to one or more standard wireless networking protocol. The one or more remote devices can comprise a personal computer, laptop computer, desktop computer, workstation computer, a smart phone, a tablet computer or any other mobile computing device. In some embodiments, the wireless communications module can also be adapted to wirelessly transmit commands to either or both of the first motor and/or the second motor.

For each and every embodiment of a method disclosed herein, systems and devices capable of performing each of those embodiments are covered within the scope of the present disclosure. For example, embodiments of wearable devices, controller units and remote computing devices are disclosed, and these devices can each have one or more processors, non-transitory memories, volatile memories, input devices, displays, mass storage devices, databases, communications circuitries (for wired and/or wireless communications), peripheral devices, power sources, that can perform any and all method steps, or facilitate the execution of any and all method steps.

### Example Embodiments of Wearable Devices for Therapeutic Loading of a Joint

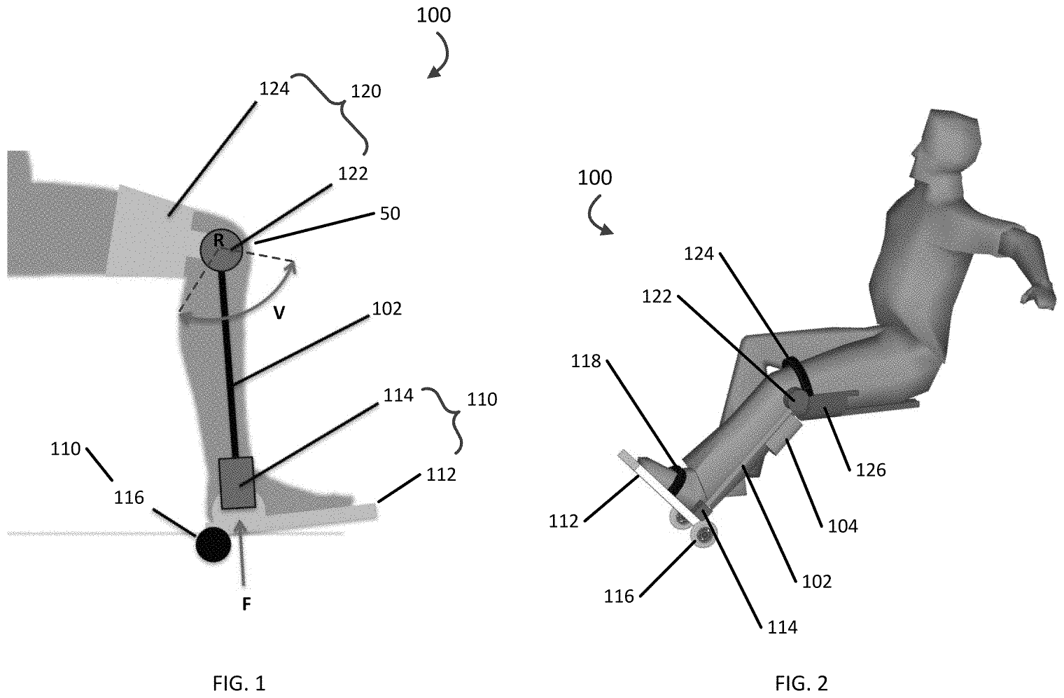

FIG. 1 is a side view of an example embodiment of a wearable device 100 for therapeutic loading of a joint 50. According to one aspect of the embodiment, wearable device 100 can include a first subassembly 110 comprising a first motor 114 coupled to an adjustable connecting element 102, wherein the first motor 114 is configured to apply a predetermined force, F, to the joint 50 through the adjustable connecting element 102. The first motor 114 can be, for example, an electric motor, a stepper motor, a pneumatic motor, a hydraulic motor, a magnetic motor, or any other similar type of linear motor adapted to generate a predetermined amount of force in a desired direction. In some embodiments, for example, first motor 114 can include an AC induction motor controlled by a variable speed drive.

In many of the embodiments disclosed herein, adjustable connecting element 102 can comprise a length-adjustable two-piece strut, beam, shaft, or rod constructed from a rigid material such as aluminum, titanium, steel, or any other rigid material adapted to transfer a predetermined force, F, exerted thereupon from first motor 114 to joint 50. In other embodiments, adjustable connecting element 102 can comprise a length-adjustable elastic cable, cord, or belt configured to apply a predetermined force, F, generated by first motor 114 onto joint 50. In still other embodiments, adjustable connecting element 102 can include one or more compressible springs, wherein the compressive force of the one or more springs can be adjusted to impart a predetermined force, F, to joint 50. Those of skill in the art will appreciate that these and other similar embodiments of adjustable connecting elements 102 can be used individually, or in combination, to impart a predetermined force, F, to joint 50, and are fully within the scope of the present disclosure.

According to another aspect of the disclosed embodiments, wearable device 100 can also include a second subassembly 120 comprising an adjustable cuff 124 coupled to the adjustable connecting element 102, wherein the adjustable cuff 124 is further coupled to an appendage that is adjacent to joint 50. In many of the embodiments, a first end of the adjustable connecting element 102 is coupled to the first motor 114, and a second end of the adjustable connecting element 102 is coupled to the adjustable cuff 124. In some embodiments, the second end of the adjustable connecting element 102 can be coupled to a second motor 122 in addition to, or instead of, the adjustable cuff 124.

As can be seen in FIG. 1, wearable device 100 can also include a second motor 122 that is configured to cause the joint 50 to articulate according to a predetermined range of motion, R, at a predetermined velocity, V. According to one aspect of the embodiments disclosed herein, the predetermined range of motion, R, can include a flexing motion and an extending motion. In some embodiments, the second motor 122 can be an electric motor, magnetic motor, pneumatic motor, hydraulic motor, a stepper motor, or any other similar type of motor adapted to generate torque, i.e., a rotational force, to cause the joint 50 to articulate according to a predetermined range of motion, R, at a predetermined velocity, V. Furthermore, in some embodiments, as seen in FIG. 1, the second motor 122 can be disposed in the second subassembly 120. Those of skill in the art will appreciate, however, that the second motor 122 can be implemented at different locations in wearable device 100, such as in the first subassembly 110, as described with respect to the embodiment of FIG. 6.

According to another aspect of the disclosed embodiments, as seen in FIG. 1, the first subassembly 110 can be located adjacent to a foot of the user, and can also include a foot plate 112 coupled to one or more wheels 116. Wheels 116 can be configured to roll upon a ground surface as joint 50 is articulated by second motor 122. Furthermore, wheels 116 can be constructed of any material suitable to allow the foot plate 112 to drive over the ground surface while joint 50 is articulated. For example, wheels 116 can be made of rubber, rigid plastic, lightweight metal, silicone, plastic foam, combinations thereof, or any other suitable material. Optionally, wheels 116 can further include a tread surface for improving traction between wheels 116 and the ground surface.

FIG. 2 is a perspective view of another example embodiment of wearable device 100 for therapeutic loading of joint 50. Similar to the embodiment described with respect to FIG. 1, wearable device 100 can include a first subassembly comprising a first motor 114 coupled to an adjustable connecting element 102, wherein the first motor 114 is configured to apply a predetermined force to the joint through adjustable connecting element 102. As seen in FIG. 2, in some embodiments, the adjustable connecting element 102 can also include a support element 104 to support an appendage adjacent to the joint. Support element 104 can be, for example, a partial cuff or brace that surrounds at least a portion of an appendage adjacent to the joint.

As can also be seen in FIG. 2, the first subassembly can include a foot plate 112, which is coupled to a plurality of wheels 116. Although FIG. 2 depicts two wheels 116, other embodiments can include one, three, four or any number of wheels 116 coupled to foot plate 112. Additionally, in some embodiments, as shown in FIG. 2, an adjustable foot strap 118 can also be coupled to foot plate 112, wherein the adjustable foot strap 118 is configured to secure the foot to the foot plate 112. The adjustable foot strap 118 can be constructed of nylon, or a similar durable material. In some embodiments, the first subassembly can optionally include one or more hinges disposed at a connection point between first motor 114 and foot plate 112 to allow the foot to remain parallel or substantially parallel to the ground surface while the joint is being articulated.

Referring still to FIG. 2, wearable device 100 can also include a second subassembly comprising an adjustable cuff 124. In some embodiments, for example, the adjustable cuff 124 can be a fitted sleeve constructed of a thin fabric material, such as spandex or polyester, and configured to be worn on at least a portion of an appendage adjacent to the joint, as shown in FIG. 1. In other embodiments, the adjustable cuff 124 can be an adjustable strap constructed from a nylon material, as shown in FIG. 2. These embodiments of adjustable cuffs are intended to be illustrative only, and are not meant to limit the scope of the embodiments. Indeed, those of skill in the art will recognize that the adjustable cuff can be constructed from one or more different materials, according to different geometries, in order to achieve the intended result of securing the wearable device 100 to an appendage adjacent to the joint.

According to another aspect of the embodiments disclosed herein, the second subassembly of wearable device 100 can also include a weight-bearing brace 126 coupled to adjustable cuff 124, wherein weight-bearing brace 126 is configured to provide additional stability and support for wearable device 100 during use. Weight-bearing brace 126 can be constructed from aluminum, titanium, steel, rigid plastic, or any other rigid material, and, as depicted in FIG. 2, can be further adapted to support the weight of the user in a seated position to prevent unwanted movement of wearable device 100 while the second motor 122 articulates the joint.

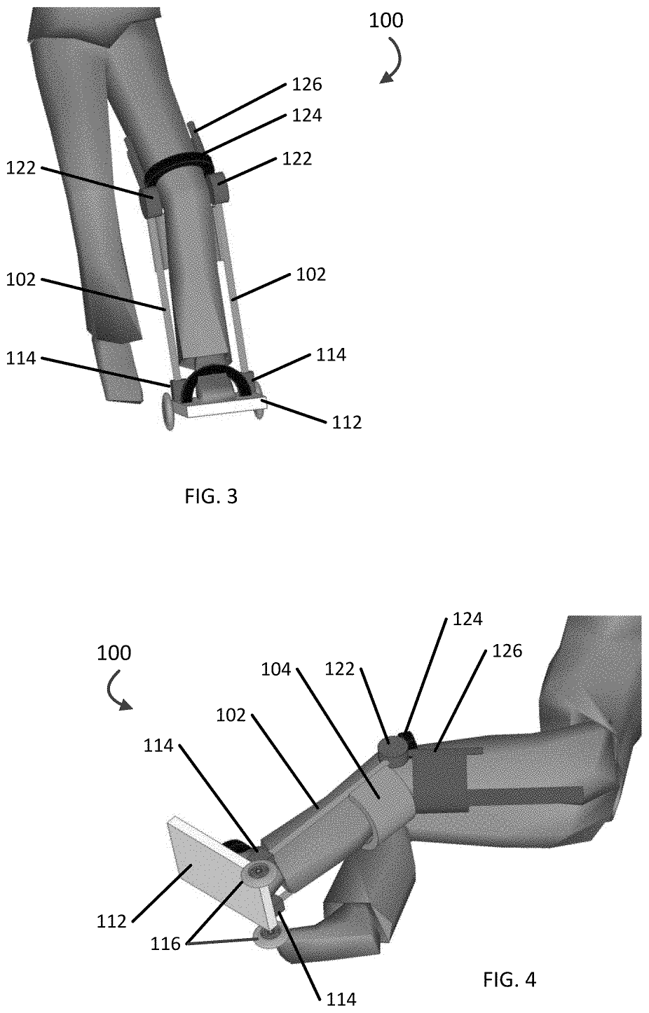

FIG. 3 depicts a front view of another example embodiment of wearable device 100 for therapeutic loading of a joint. Similar to the previously described embodiments, wearable device 100 can include a first subassembly, a second subassembly, a weight-bearing brace 126, an adjustable cuff 124, a support element, and a foot plate 112 coupled to one or more wheels. Additionally, as can be seen in FIG. 3, in some embodiments, the first subassembly can include a first set of motors 114, each of which is coupled to separate first ends of a set of adjustable connecting elements 102. The first set of motors 114 can be configured to apply a predetermined force to the joint through each corresponding adjustable connecting element 102. Similarly, as can be seen in FIG. 3, in some embodiments, wearable device 100 can include a second set of motors 122, each of which can be configured to cause the joint to articulate according to a predetermined range of motion at a predetermined velocity. Each of the second set of motors 122 can be coupled to a corresponding adjustable connecting element 102 at a second end.

According to one aspect of the embodiments disclosed herein, the first set of motors 114 can be coupled to foot plate 112, and configured, along with the corresponding adjustable connecting elements 102, in a symmetrical fashion around the user's appendage to ensure that the predetermined force is translated to the joint in a desired direction, to provide stability during use, and to prevent unwanted movement of wearable device 100. Similarly, the second set of motors 122 can be coupled to either or both of the weight-bearing brace 126 and/or the adjustable cuff 124, along with the corresponding adjustable connecting elements 102, in a symmetrical fashion around the user's appendage to ensure that the predetermined range of motion is translated to the joint in a desired and predictable manner, to provide stability during use, and to prevent unwanted movement of wearable device 100. Furthermore, although FIG. 3 depicts the first set of motors 114 as including two motors, and the second set of motors 122 as including two motors, it will be understood by those of skill in the art that other numbers of motors (one, three, four, five, etc.) for either the first or second set of motors can be utilized, and are fully within the scope of the present disclosure.

FIG. 4 is a bottoms-up perspective view of another example embodiment of a wearable device for therapeutic loading of a joint. Similar to the previously described embodiments, wearable device 100 can include a first subassembly, a second subassembly, a weight-bearing brace 126, an adjustable cuff 124, a support element 104, and a foot plate 112 coupled to one or more wheels 116. Additionally, as can be seen in FIG. 4, in some embodiments, the first subassembly can include a first set of motors 114, each of which is coupled to a separate adjustable connecting element 102, and a second set of motors 122, each of which can also be coupled to a corresponding adjustable connecting element 102.

Referring still to FIG. 4, the weight-bearing brace 126 can be coupled to either or both of the adjustable strap 124 and/or the second set of motors 122. In many of the embodiments, the weight-bearing brace 126 can include a first portion with a curved surface configured to receive a bottom part of an appendage adjacent to the joint. In some embodiments, the weight-bearing brace 126 can also include a second portion with a flat surface fixedly coupled to the first potion of weight-bearing brace 126, wherein the second portion can have a length substantially equal to the length of the user's appendage. According to one aspect of the embodiments disclosed herein, when the user is in a seated position on an external sitting surface (e.g., a chair, bench, bed, etc.), a substantial portion of the user's weight can rest upon the second portion of the weight-bearing brace 126, thereby “anchoring” the second assembly to the external sitting surface and preventing unwanted movement or shifting of wearable device 100 when in use. Although depicted as a flat “plank-like” surface in FIG. 4, those of skill in the art will recognize that the second portion can have other geometries, such as, for example, a curved surface, a textured or ridged surface, or any other surface configured to promote stability of wearable device 100 while the user is in a seated position.

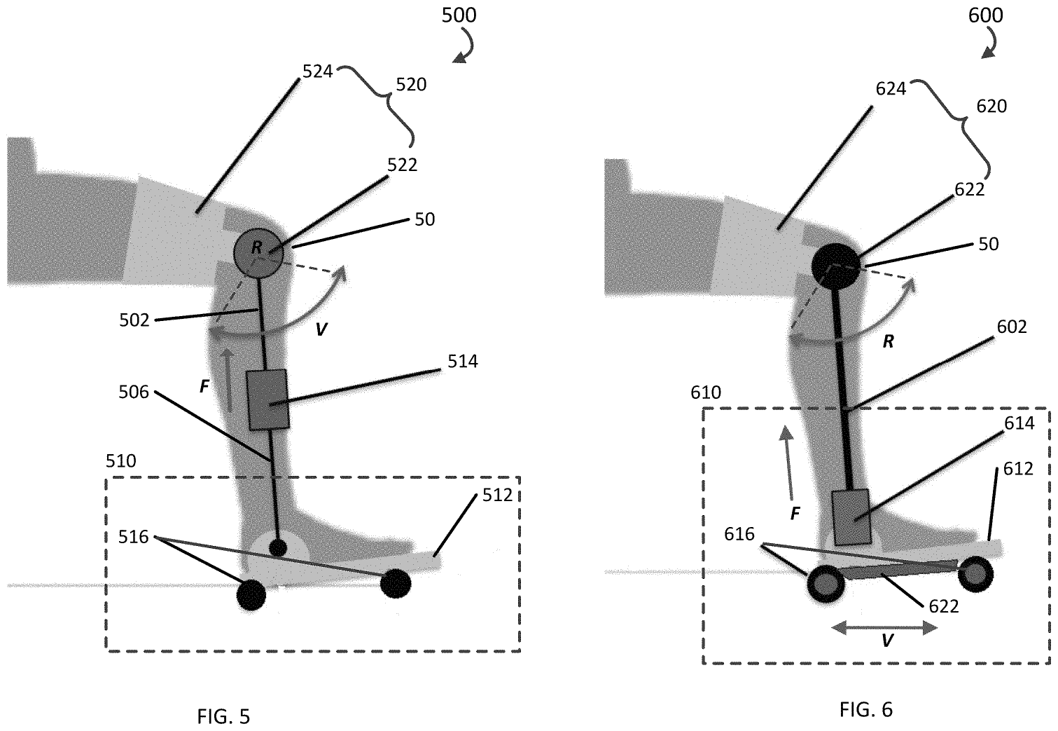

FIG. 5 is a side view of another example embodiment of a wearable device 500 for therapeutic loading of a joint 50. Similar to the previously described embodiments, wearable device 500 can include a first subassembly 510 comprising a foot plate 512 coupled to one or more wheels 516. With respect to these embodiments, however, wearable device 500 can include multiple adjustable connecting elements coupled to a first motor 514, as depicted in FIG. 5. In some embodiments, for example, foot plate 512 can be coupled to a first end of the first adjustable connecting element 506. Furthermore, the first motor 514 can be coupled to a second end of the first adjustable connecting element 506, and first motor 514 can also be coupled to a first end of a second adjustable connecting element 502, and configured to apply a predetermined force, F, to joint 50 through the second adjustable connecting element 502.

In some embodiments, the first motor 514 does not apply a force to first adjustable connecting element 506. In other embodiments, however, the first motor 514 can comprise multiple actuators (not shown), including a first actuator coupled to the first adjustable connecting element 506, and a second actuator coupled to the second adjustable connecting element 502. The first and second actuators of the first motor 514 can operate in conjunction to generate a predetermined resultant force, F, to joint 50.

In many of the embodiments disclosed herein, wearable device 500 can also include a second subassembly 520 comprising an adjustable cuff 524 coupled to the second adjustable connecting element 502, wherein adjustable cuff 524 is further coupled to an appendage adjacent to joint 50. In some embodiments, a second motor 522 can be disposed in the second subassembly 520, wherein the second motor is configured to cause joint 50 to articulate according to a predetermined range of motion, R, at a predetermined velocity V. In some embodiments, second adjustable connecting element 502 can be coupled to the second motor 522 in addition to, or instead of, the adjustable cuff 524.

FIG. 6 is a side view of another example embodiment of a wearable device 600 for therapeutic loading of a joint 50. According to one aspect of the embodiments, wearable device 600 can comprise a first subassembly 610, which can include a first motor 614 coupled to an adjustable connecting element 602. Similar to the previously described embodiments, first motor 614 can be configured to apply a predetermined force, F, to joint 50 through adjustable connecting element 602. First subassembly 610 can also include a foot plate 612 coupled to one or more wheels 616, the one or more wheels configured to roll upon a ground surface.

According to another aspect of the embodiments, first subassembly 610 can also include a second motor 622 coupled to foot plate 612 and the one or more wheels 616, wherein the second motor 622 can be configured to drive foot plate 612 forward and back over a ground surface at a controlled rate. For example, in some embodiments, second motor 622 can be housed within or underneath foot plate 612 and adapted to apply torque to at least one of the wheels 616, causing wheels 616 to roll on the ground surface. In this manner, the movement caused by second motor 622 can cause joint 50 to articulate according to a predetermined range of motion, R, such as in a flexion-extension motion, at a predetermined velocity, V.

Referring still to FIG. 6, wearable device 600 can also include a second subassembly 620 comprising an adjustable cuff 624 coupled to an appendage adjacent to joint 50. In some embodiments, second subassembly 620 can also include a hinge joint 626 coupled to adjustable cuff 624 and adjustable connecting element 602. According to one aspect of the embodiments, hinge joint 626 can be configured to rotate in response to the movement of adjustable connecting element 602 caused by first subassembly 610. In some embodiments, hinge joint 626 can be further configured to provide a predetermined amount of resistance to the movement of adjustable connecting element 602. In still other embodiments, adjustable cuff 624 can be fixedly coupled directly to adjustable connecting element 602, without the use of a hinge joint.

Moreover, although the above figures depict the wearable device in use with a knee joint, those of skill in the art will recognize that the embodiments disclosed herein can be utilized with other joints and appendages of the user's body. For example, the disclosed embodiments can be used to provide therapeutic loading of an elbow joint, wherein the adjustable cuff is coupled to an arm. Accordingly, the application of wearable device to other joints and appendages are fully within the scope of the present disclosure.

### Example Embodiments of Controller Units

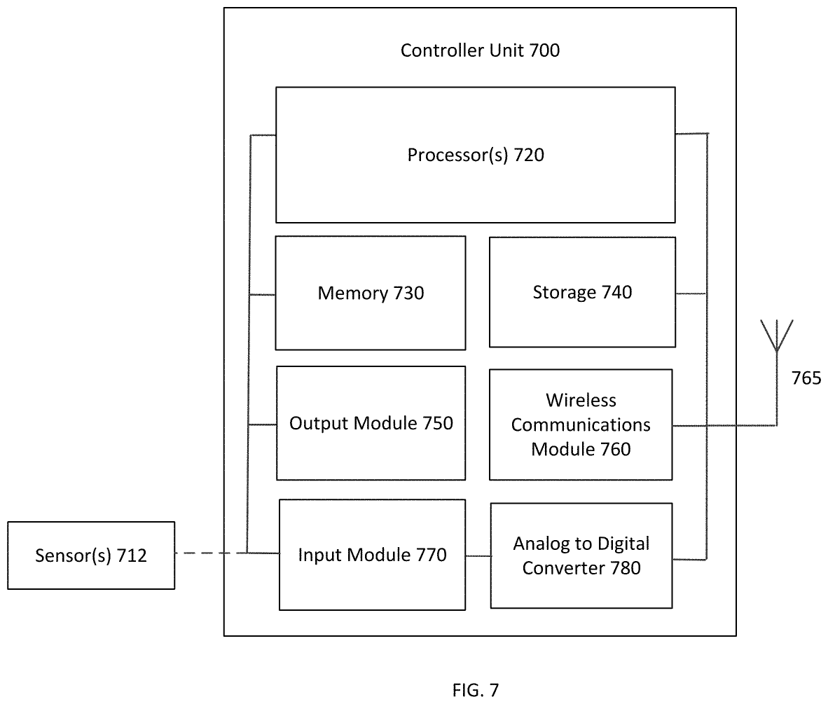

FIG. 7 is a block diagram depicting an example embodiment of a controller unit 700 for use with any of the previously described embodiments. Controller unit 700 can be disposed in either the first subassembly, the second subassembly, or separately coupled to the adjustable connecting element. Those of skill in the art will understand that these configurations are meant to be illustrative and non-limiting, and that controller unit 700 can be placed in other locations of the wearable device.

In many of the embodiments disclosed herein, controller unit 700 unit can comprise one or more of the following components: one or more processors 720; a memory 730, which can include non-transitory memory, RAM, Flash or other types of memory; a mass storage device 740; an output module 750, which can be configured to output data to a visual display, or output an auditory or vibratory signal; a wireless communications module 760 (coupled with an antenna 765), which can be configured to transmit and/or receive data and/or commands with a remote computing device, or with either or both of the first or second motors, according to a standard wireless networking protocol, such as, for example, 802.11x, Bluetooth, Bluetooth Low Energy, Near Field Communications (NFC), UHF or infrared network protocol; one or more sensors 712; an analog-to-digital converter 780 configured to convert an analog signal into a digital signal; a power supply (not shown), which can be a battery; and an input module 770, which can be configured to receive input from devices including keyboards, keypads, mice, trackpads, touchpads, microphones and other user input devices.

In some embodiments, processors 720 can include, for example, a general-purpose central processing unit (“CPU”), a graphics processing unit (“GPU”), an application-specific integrated circuit (“ASIC”), a field programmable gate array (“FPGA”), or any other type of processor, e.g., Application-specific Standard Products (“ASSPs”), Systems-on-a-Chip (“SOCs”), Programmable Logic Devices (“PLDs”), and other similar components. Processors can also include one or more processors, microprocessors, controllers, and/or microcontrollers, each of which can be a discrete chip or distributed amongst (and a portion of) a number of different chips, and collectively, can have the majority of the processing capability for performing any of the methods described herein. As understood by one of skill in the art, the aforementioned components are electrically and communicatively coupled in a manner to make one or more functional devices.

According to another aspect of the embodiments disclosed herein, sensors 712 can be adapted to generate one or more signals in response to at least one of a plurality of physiological characteristics or movements of a user, including body temperature, heart rate, blood pressure, electrocardiogram, body position, velocity and/or position of an appendage. In some embodiments, for example, sensors 712 include one or more accelerometers for measuring acceleration, including but not limited to, single- or three-axis accelerometers; magnetometers for measuring the Earth's magnetic field and a local magnetic field in order to determine the location and vector of a magnetic force; global positioning system (GPS) sensors; gyroscope sensors for measuring rotation and rotational velocity; or any other type of sensor configured to measure the velocity, acceleration, orientation, and/or position of the wearable device, the user's body position or the position/orientation of a particular appendage of the user's body. In many of the embodiments, sensors 712 can also comprise force-measuring sensors made from a piezoelectric material, such as lead zirconate titanate, barium titanate, sodium potassium niobate, potassium niobate, or sodium tungstate. Those of skill in the art will recognize that other materials having piezoelectric properties can be utilized, and that said materials are fully within the scope of the present disclosure. In other embodiments, sensors 712 can comprise one or more piezoresistive sensors, force-sensing resistors, thin-film strain gauge sensors, thin-film capacitive sensors, or any other type of sensor configured to measure force generated by the first or second motors. In other embodiments, sensors 712 can also include temperature and pressure sensors for measuring environmental conditions. In many of the embodiments, the sensors 712 can comprise microelectromechanical (MEMS) devices.

According to another aspect of the embodiments disclosed herein, memory 730 can store instructions that, when executed by the one or more processors 720, cause the one or more processors 720 to maintain, increase, decrease and/or otherwise control at least one of the predetermined force of the first motor, the predetermined range of motion of the second motor, and the predetermined velocity of the second motor. In some embodiments, for example, instructions stored in memory 730, when executed by the one or more processors 720, can cause the one or more processors 720 to adjust one or more of the predetermined force, predetermined range of motion, and the predetermined velocity according to a programmable schedule. As a further example, a user recovering from a traumatic injury to a particular joint may program controller unit 700 to gradually increase the predetermined range of motion and velocity of the second motor according to a schedule recommended by a physical therapist.

In other embodiments, instructions stored in memory 730, when executed by the one or more processors 720, can cause the one or more processors 720 to monitor data received by the one or more sensors 712 and adjust at least one of the predetermined force, predetermined range of motion, or predetermined velocity accordingly. In this manner, sensors 712 provide a feedback loop to controller unit 700 to ensure that the first and second motors are operating correctly.

In still other embodiments, instructions stored in memory 730, when executed by the one or more processors 720, can cause the one or more processors 720 to wirelessly transmit data via the wireless communications module 760 to a remote computing device, such as, for example, a personal computer (PC), a laptop computer, a desktop computer, a workstation computer, a smart phone, a tablet computer, or a mobile computing device. In some embodiments, the data can be transmitted according to a standard wireless networking protocol, such as, 802.11x, Bluetooth, Bluetooth Low Energy, Near Field Communication (NFC), UHF, or an infrared networking protocol. According to another aspect of the embodiments disclosed herein, the transmitted data can include physiological characteristics of the user, as sensed by sensors 712, including but not limited to body temperature, heart rate, blood pressure, electrocardiogram, body posture, and position of an appendage. Those of skill in the art will appreciate that other physiological characteristics can be sensed by sensors 712 and monitored on a remote computing device, and are fully within the scope of the present disclosure.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A wearable device for providing therapeutic loading of a joint, the wearable device comprising:
a first subassembly comprising a first motor coupled to an adjustable connecting element, wherein the first motor is configured to apply a predetermined force to the joint through the adjustable connecting element;
a second subassembly comprising an adjustable cuff coupled to the adjustable connecting element, wherein the adjustable cuff is further coupled to an appendage adjacent to the joint; and
a second motor configured to cause the joint to articulate according to a predetermined range of motion at a predetermined velocity.

2. The wearable device of claim 1, wherein a first end of the adjustable connecting element is coupled to the first motor, and a second end of the adjustable connecting element is coupled to the adjustable cuff.

3. The wearable device of claim 1, wherein the second motor is disposed in the second subassembly.

4. The wearable device of claim 1, wherein the second motor is disposed in the first subassembly.

5. The wearable device of claim 1, wherein the joint is a knee joint and the appendage is a leg.

6. The wearable device of claim 5, wherein the first subassembly is adjacent to a foot and further comprises a foot plate coupled to a plurality of wheels, the plurality of wheels configured to roll upon a ground surface as the knee joint is articulated.

7. The wearable device of claim 1, wherein the adjustable connecting element comprises a strut constructed of a rigid material.

8. The wearable device of claim 1, wherein the adjustable connecting element comprises an elastic cable.

9. The wearable device of claim 1, wherein the adjustable connecting element includes one or more compressible springs.

10. The wearable device of claim 5, wherein the predetermined range of motion includes a flexing motion and an extending motion.

11. The wearable device of claim 7, wherein the first motor is further configured to apply a push force against the strut.

12. The wearable device of claim 8, wherein the first motor is further configured to apply a pulling force on the elastic cable.

13. The wearable device of claim 9, wherein the first motor is further configured to apply a compressive force to the one or more compressible springs.

14. The wearable device of claim 1, wherein the joint is an elbow joint.

15. The wearable device of claim 1, further comprising a controller unit, the controller unit comprising:
one or more processors,
a memory coupled to the one or more processors, the memory configured to store instructions that, when executed by the one or more processors, cause the one or more processors to control at least one of the predetermined force of the first motor, the predetermined range of motion of the second motor, and the predetermined velocity of the second motor.

16. The wearable device of claim 15, wherein the instructions stored in memory, when executed by the one or more processors, further cause the one or more processors to apply at least one of the predetermined force of the first motor, the predetermined range of motion of the second motor, and the predetermined velocity of the second motor according to a programmable schedule.

17. The wearable device of claim 15, wherein the controller unit further comprises a wireless communications module coupled to the one or more processors, wherein the wireless communications module is configured to transmit and receive data to a remote computing device according to one or more standard wireless networking protocols.

18. The wearable device of claim 17, wherein the one or more standard wireless networking protocol comprises one or more of an 802.11x, Bluetooth, Bluetooth Low Energy, Near Field Communication (NFC), UHF, or infrared networking protocol.

19. The wearable device of claim 15, wherein the controller unit further comprises one or more sensors and an analog-to-digital converter coupled to the one or more processors, wherein the one or more sensors are adapted to generate one or more signals in response to at least one of a plurality of physiological characteristics of a user, including body temperature, heart rate, blood pressure, electrocardiogram, body posture and position of an appendage.

20. The wearable device of claim 19, wherein the instructions stored in the memory of the controller unit, when executed, further cause the one or more processors to perform one or more adjustment routines based at least in part on the one or more signals generated by the one or more sensors, wherein the one or more adjustment routines are configured to adjust at least one of the predetermined force of the first motor, and the predetermined range of motion and the predetermined velocity of the second motor.
